(19) United States
(12) Patent Application Publication
(10) Pub. No.: US 2024/0154476 A1
(43) Pub. Date: May 9, 2024

(54) PERMANENT MAGNET SYNCHRONOUS MOTOR

(71) Applicant: Siemens Aktiengesellschaft, 80333 München (DE)

(72) Inventor: FRANK RETTINGER, Bad Neustadt (DE)

(73) Assignee: Siemens Aktiengesellschaft, 80333 München (DE)

(21) Appl. No.: 18/280,594

(22) PCT Filed: Mar. 15, 2022
(86) PCT No.: PCT/EP2022/056616

§ 371 Date: Sep. 6, 2023

(30) Foreign Application Priority Data
Mar. 19, 2021 (EP) 21163755.8

(51) Int. Cl. H02K 1/276; H02K 21/14

(52) U.S. Cl. CPC H02K 1/276; H02K 21/14

(57) ABSTRACT

A rotor of a rotatory permanently excited synchronous machine includes a magnetically conductive body having recesses, each designed with a pocket for receiving permanent magnets. Flux barriers are arranged at opposed ends of the pockets. In a region between the pockets and the flux barriers for increasing an opposing field stability are holding elements on the ends of the pockets to assist in positioning and fixing of the permanent magnets in the pockets, with the holding elements having at least one section to form the pockets and designed on an air-gap side of the pockets such as to counteract an irreversible demagnetization of the permanent magnets in the pockets and to maintain a protective function for the permanent magnets in the event of a fault such as a sudden short-circuit of the permanently excited synchronous machine. Sheet metal webs are arranged between the recesses of a pole of the rotor.

The invention relates to a rotor of a permanently excited synchronous machine and to a permanently excited synchronous machine.

As a rule, permanently excited synchronous machines are configured in such a way that in the event of a fault they withstand, for example, a sudden short-circuit in the winding system of the stator of the permanently excited synchronous machine, without appreciable irreversible demagnetization of the permanent magnets. A fault of this kind places high demands on the configuration of the permanently excited synchronous machine and the magnetic materials used and the arrangement thereof in the rotor.

Exposed regions of the permanent magnets, for example the corners of the permanent magnets, are particularly at risk in this case since they are exposed to particular high opposing fields in the event of a fault. Accordingly, irreversible demagnetization of the permanent magnets will occur there first of all.

In the case of permanently excited synchronous machines having buried permanent magnets, the permanent magnets are axially pushed into pockets present in the rotor. As a rule, the permanent magnets are positioned inside the pocket by way of “positioning webs”.

In the case of known machine configurations, these webs are situated on the shaft side of the magnetic pocket, as can also be found in U.S. Pat. No. 9,531,226 B2 and US 2018/0248427 A1.

As a rule, the sudden short-circuit resistance of the machine can be achieved by using magnetic qualifies with high HcJ and/or by using thicker magnets.

This increases the costs of the motor due to higher-quality magnets and/or greater use of materials.

Taking this as a starting point, the invention is based on the object of creating a rotor or a permanently excited synchronous machine having improved opposing field stability hi order to be able to guarantee reliable operation, even in extraordinary operating states, in particular in industrial applications.

The solution to the stated object occurs by way of a rotor having buried permanent magnets, which are arranged in substantially axially extending recesses or a magnetically conductive body, in particular of an axially layered laminated core of the rotor, wherein each recess has a pocket for receiving one or more permanent magnet(s), wherein flux barriers are situated in a longitudinal axis of the recess at the opposed ends of the pockets, wherein, in the region between pocket and flux barrier, means for increasing an opposing field stability are provided at the side of the recesses facing an external diameter of the rotor.

The solution to the stated object also occurs by way of a permanently excited synchronous machine having a stator and a rotor spaced apart therefrom by an air gap, having buried permanent magnets, which are arranged in substantially axially extending recesses of a magnetically conductive body, in particular of an axially layered laminated core of the rotor, wherein each recess has a pocket for receiving one or more permanent magnet(s), wherein flux barriers are situated in a longitudinal axis of the recess at the opposed ends of the pockets, wherein, in the region between pocket and flux barrier, means for increasing an opposing field stability are provided at the side of the recesses facing an external diameter of the rotor in order to counteract, in particular, a sudden short-circuit of the permanently excited synchronous machine of an, at least in certain sections, irreversible demagnetization of the permanent magnet in the pockets.

The means for opposing field stability on the side of the recesses facing the external circumference of the rotor in the region between flux barriers and pockets is especially effective. There, the demagnetization field, which is optionally generated by a sudden short-circuit current in a winding system of a stator, normally has a particularly adverse effect. This can be especially reduced by these means, which are configured, in particular, as holding elements or webs.

An opposing field of this kind can result, for example, due to a sudden short-circuit current, other load states of the permanently excited synchronous machine, high overload moments, faulty current impressions of the inverter and diverse short-circuit faults in the winding system.

Advantageously, these webs, holding elements, functional holding parts are part of the dynamo metal sheet of the rotor and are configured in one piece with it. This is guaranteed, for example, by a stamping process. The dimensioning of the webs is configured in such a way that they can continue to perform the protective function for the permanent magnets, for example due to a short-circuit current and the demagnetization field resulting therefrom and the saturation of the webs that optionally occurs therewith. In other words, the protective function for the permanent magnet(s) is performed independently of whether the web or the holding element reach saturation.

These holding elements, in particular webs and functional holding webs, are designed in such a way that they have an extension in the direction of the longitudinal axis as well as an extension in the direction of a transverse axis. In the direction of the longitudinal axis the extension will extend at most up to half of the magnetic thickness of the adjacent permanent magnet in order to not generate a magnetic short-circuit between the magnetic poles of the permanent magnet. In other words, in the direction of the longitudinal axis the holding element will extend most up to the transition region between north pole (N) and south pole (S).

In the direction of the transverse axis of the recess the dimensioning of the holding element or web or functional holding web will be oriented, inter alia, by the saturation of the material of the dynamo metal sheet.

In any case, however, it should be possible for the protective function for the permanent magnets to be performed by the holding elements, in particular webs and functional holding webs.

The arrangement of webs and functional holding webs on the air gap-side of the pocket significantly increases the opposing field stability of the rotor. The webs and functional holding webs conduct the opposing webs around the corners, as it were, of the permanent magnet and thereby induce a much more homogeneous loading of the permanent magnet in the event of a fault. The strong field elevations at the corners of the permanent magnet are inventively noticeably reduced. Thus, for example, the admissible fault current in the winding system of the stator can thereby be inventively increased by ˜15% compared to previous designs of the recesses of a pocket for the permanent magnets of a rotor.

In addition, the positioning function of the permanent magnets in the recesses can also be assumed by the webs.

In a further embodiment, the webs or holding elements on the pockets are not always configured on both sides and instead can also be arranged alternately, viewed over the axial length of the rotor. This is also sufficient for the positioning tasks, since, for example, a permanent magnet extends over the axial length of twenty metal sheets, so the holding elements can also be present alternately only on every fifth metal sheet or pocket. The crucial factor in the number of holding elements is whether the opposing field stability continues to be provided to the required extent by the limited selection of the holding elements.

The rotor of the permanently excited synchronous machine has poles, with each pole having only one recess or a plurality of recesses. The recesses can be arranged, for example, in the tangential direction. Similarly, they can be embodied in a V-shape arrangement or a double V-shaped arrangement or a U-shape or a W-shape or a roof shape.

The arrangement of the recesses or the permanent magnets in the poles of the rotor depends on the utilization rate of the permanently excited synchronous machine. Higher air gap densities of the magnetic field may be achieved by way of flux concentration, as is possible, for example, with a V-shaped arrangement or a double V-shaped arrangement or a U-shape.

If it has a plurality of permanent magnets each pole can also have permanent magnets of differing quality and material properties in order to design the air gap field accordingly.

A canting and/or staggering of the rotor or its poles, viewed over the axial length of the rotor, can continue to be performed in this connection. This reduces, inter alia, latching moments of the permanently excited synchronous motor.

Applications of rotors of this kind in permanently excited synchronous machines are provided primarily in an industrial sector, such as in pumps, ventilators, compactors, compressors, roller tables, conveying systems, which have a very long continuous operating time. Their use in traction drives, such as mining vehicles, electric busses, trams or trains, is also conceivable.

The invention and further advantageous embodiments of the invention will be explained in more detail on the basis of schematically represented exemplary embodiments. In the drawings:

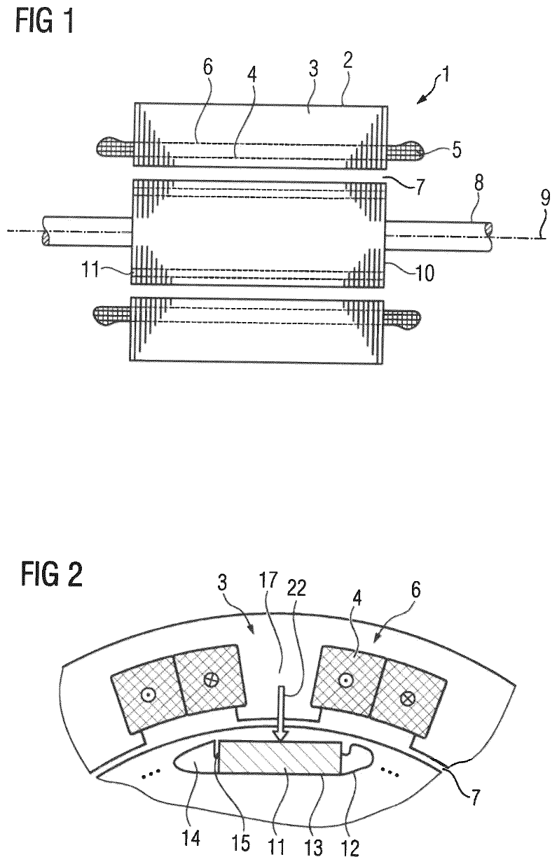

FIG. 1 shows a schematic longitudinal detail a dynamoelectric machine,

FIG. 2 shows a detailed view of a cross-section of a dynamoelectric machine,

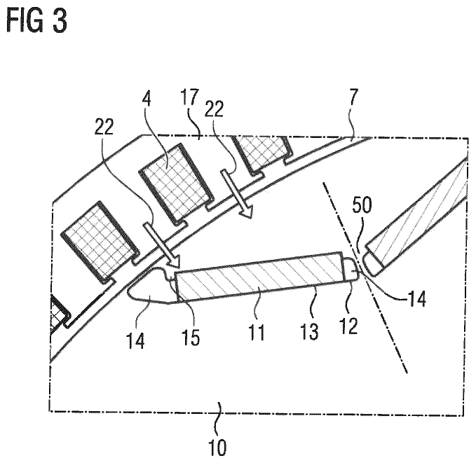

FIG. 3 shows a further detailed view of a cross-section of a dynamoelectric machine,

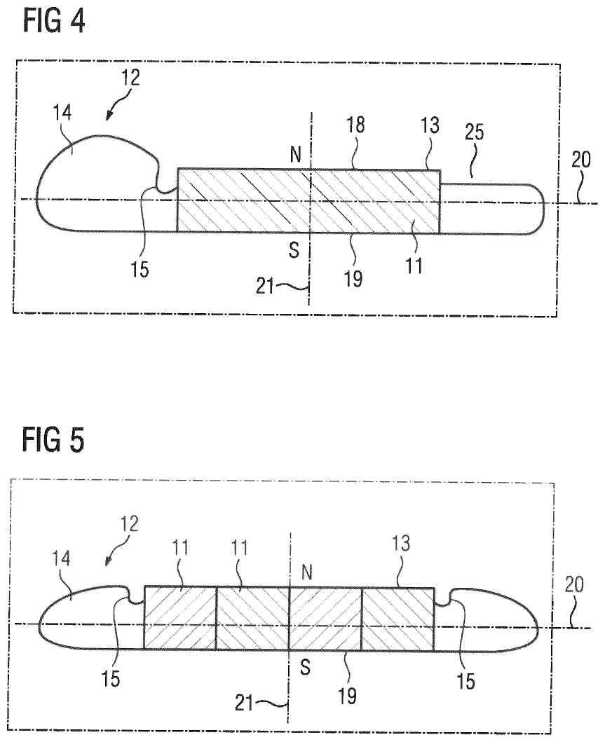

FIGS. 4 to 8 show detailed representations of different recesses of a rotor,

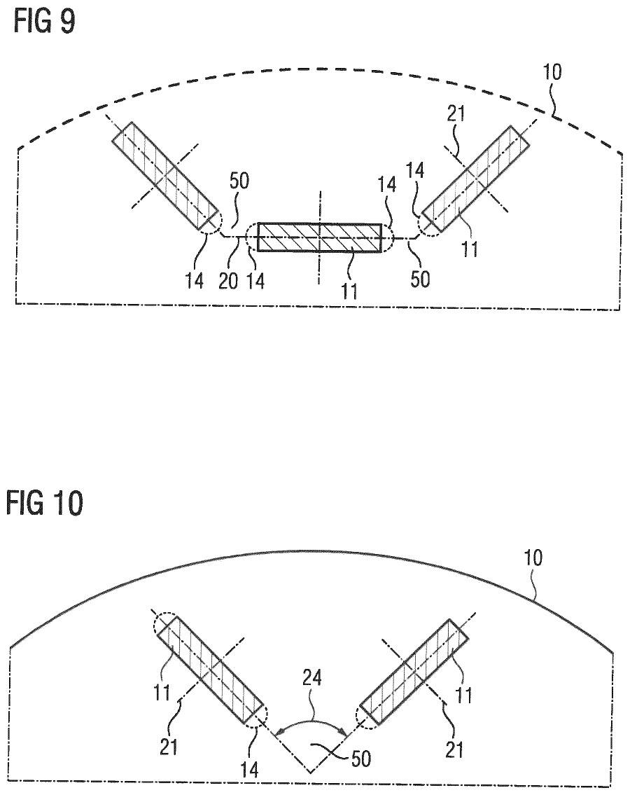

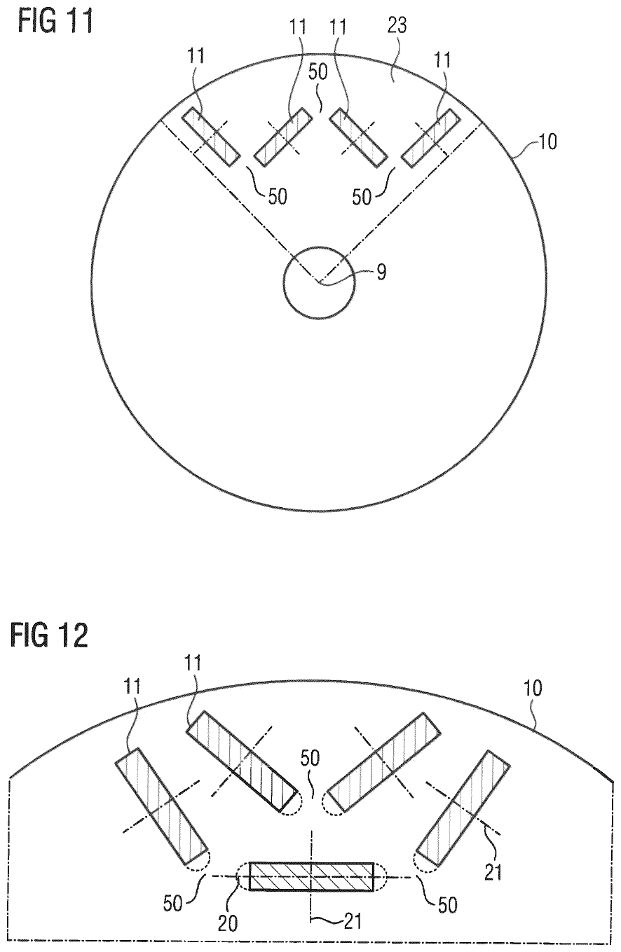

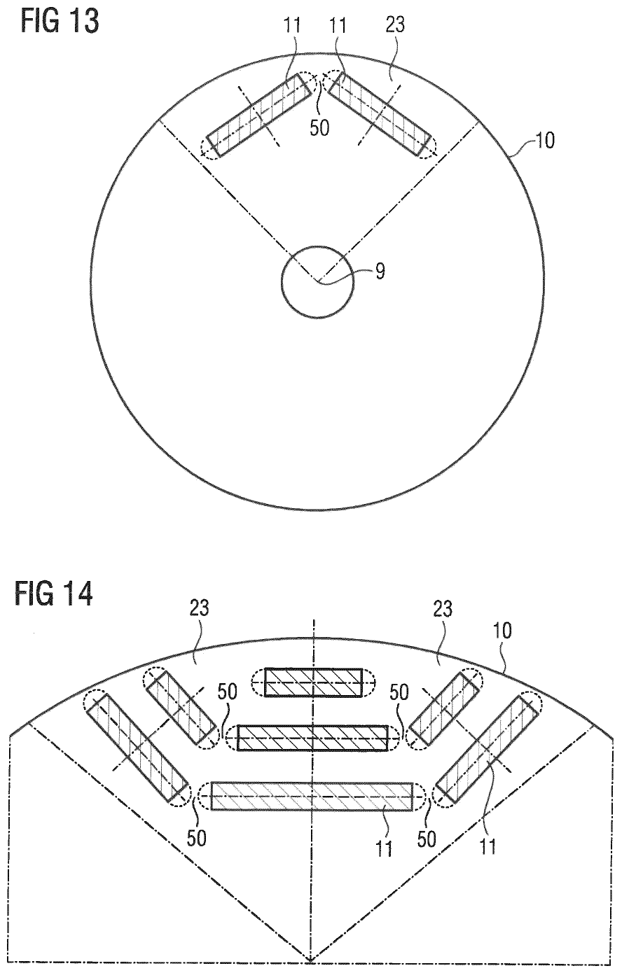

FIGS. 9 to 14 show arrangements of permanent magnets of a pole of a rotor.

It should be noted that terms such as “axial”, “radial”, “tangential”, etc. refer to the axis 9 used in the respective figure or in the respectively described example. In other words, the directions: axial radial, tangential always refer to an axis or rotation of a rotor 10 and therewith to the corresponding axis of symmetry of a stator 2. “Axial” describes a direction parallel to the axis 9, ° radar describes a direction orthogonal to the axis 9, towards it or also away from it, and “tangential” is a direction which is directed at a constant radial spacing from the axis 9 and with a constant axial position, circularly around the axis. The expression “in the circumferential direction” can be equated with “tangential”.

In relation to a face, for example a cross-sectional face, the terms “axial”, radial“, “tangential”, etc. describe the orientation of the normal vector of the face, that is to say, of that vector, which is perpendicular to the affected face.

In conjunction with component parts, for example with coils or stator teeth, the term “adjacent” should express that in the case of “adjacent component parts”, in particular no further component part of this kind is situated between these two component parts, and instead there should be, at most, an empty space or optionally a different type of component part.

The expression “coaxial component parts”, for example coaxial components such as rotor 10 and stator 2, is here taken to mean component parts, which have identical normal vectors for which the planes defined by the component parts are therefore parallel to each other. Furthermore, the expression should include the fact that the center points of coaxial component parts lie on the same axis of rotation or symmetry. These center points can, however, therefore lie optionally at different axial positions on this axis and said planes have a spacing >0 from each other. The expression does not necessarily demand that coaxial component parts have the same radius.

In conjunction with two components, which are “complementary” to each other, the term “complementary” means that their external shapes are configured in such a way that the one component can be arranged preferably completely in the component that is complementary to it, so the inner surface of the one component, for example a longitudinal side of a pocket 13, and the external surface of the other component, for example a permanent magnet 11, ideally touch without gaps or over the full face. Consequently, in the case of two mutually complementary articles, the external shape of the one article is therefore defined by the external shape of the other article. The term “complementary” could be replaced by the term “inverse”. However this does not fundamentally rule out a space being present between two complementary shapes, which space is at least partially taken up by air or adhesive or casting compound.

For the sake of clarity, not all represented component parts are partially provided with reference characters in the figures in the cases in which component parts are present several times.

FIG. 1 shows in a schematic longitudinal detail a dynamoelectric machine 1, in particular a permanently excited synchronous machine, having a stator 2 and a rotor 10, which is non-rotatably connected to a shaft 8. In grooves (not represented) of a laminated core the stator 2 has a winding system 4, which embodies winding heads 5 at the end faces of the laminated core 3.

In this embodiment the rotor 10 has buried permanent magnets 11, which are arranged in substantially axially extending pockets of a laminated core of the rotor 10. Permanent magnets 11, which are not arranged on the external surface of the rotor 10, are regarded as buried permanent magnets 11 in this case.

The rotor is caused to rotate about an axis 9 by electromagnetic interaction of the rotor 10 with a stator 2 energized by the winding system 4. The rotor 10 is separated from the stator 2 by an air gap 7.

FIG. 2 shows a detailed view of a cross-section of the dynamoelectric machine, with the winding system 4 of the stator 2 being configured there as a tooth coil. Two different sides of adjacent tooth coils per groove are provided in this winding system 4. The invention may also be used in other winding systems of the stator 2, for example tooth-coil windings, distributed windings, such as single-layer whole-slot windings, two-layer whole-slot windings (desired) and generally in two-layer fractional slot windings. The wire shapes used in this case (round and flat wire windings as well as stranded wires) are also almost arbitrary.

The rotor 10 with its permanent magnets 11 is arranged separated from the stator 2 by the air gap 7. In this embodiment these permanent magnets 11 are arranged more or less tangentially inside the rotor 10. The permanent magnet 11 has a cuboidal configuration and is situated in a pocket 13. The pocket 13 is part of a recess 12, with the section, which is not taken up by the permanent magnet 11 inside the recesses 12, preferably being embodied as flux barriers 14.

These flux barriers 14 have either air or amagnetic material. The flux barriers 14 in the poles or around the pockets 13 of the rotor 10 are necessary to avoid magnetic short-circuits of the permanent magnets 11 in the region of the respective pole.

Provided between the flux barriers 14 and the pockets are webs 15, which are provided on the side of the recess 12 facing the air gap 7. A demagnetization of the permanent magnet 11, in particular in the fringes of the permanent magnets 11, for example due to a sudden short-circuit in the winding system 4, can be largely avoided by way of this inventive arrangement of the webs 15.

FIG. 3 shows in a further detailed view of a cross-section of a dynamoelectric machine 1, a stator 2, a winding system 4, which is arranged in grooves 6 of the laminated core 3. Teeth 17 between the grooves 6 point toward the air gap 7 and guide the magnetic field induced by the energized winding system 4.

In this embodiment the rotor 10 has permanent magnets 11 arranged in a V-shape, which form a pole of the rotor 10. The V-shaped arrangement of the permanent magnets 11 has the advantage that, inter glia, the magnetic field density in the air gap 7 is increased. Reference is also made to a flux concentration.

Here too, webs 15 are arranged between the flux barriers 14 and the pockets 13 on the side of the recesses 12 facing the air gap 7, which webs counteract a demagnetization of the permanent magnets 11 in a sudden short-circuit of the winding system 4.

FIG. 4 shows a detailed view of a recess 12. The recess 12 has a region in which the permanent magnets 11 are arranged. This is referred to as a pocket 13. The permanent magnets 11 abut against the longitudinal sides 18, 19 of the pocket 13 in a complementary manner. In other words, a continuous contact, optionally with an adhesive layer provided by metal sheets and permanent magnet 11, is present.

As a rule, the pocket 13 is designed to be slightly larger than the permanent magnet 11 since space for joining and/or tolerances has to be taken into account. This optionally free space is then filled with adhesive or casting compound or, with other types of attachment, such as jamming or caulking, can also just be air.

There is thus an outside longitudinal side 18 and an inside longitudinal side 19. The outer longitudinal side 18 points substantially towards the air gap 7; the inner longitudinal side 19 towards the shaft 8. The permanent magnet 11 is inserted into the pocket 13 in such a way that its north pole and its south pole are arranged on the longitudinal sides respectively. That is to say, the north pole is situated on the outside longitudinal side 18 and the south pole on the inside longitudinal side 19 accordingly. Depending on how the poles of the rotor 10 are configured, a plurality of pockets 13 have a corresponding arrangement of the permanent magnets 11 in the pockets 13.

The transition region between north pole and south pole of the permanent magnet 11 extends substantially in the longitudinal axis of the recess 12. Perpendicular to the longitudinal axis 20 of the recess 12 there is a transverse axis 21 of the recess 12, which substantially matches the magnetization direction of the permanent magnet 11.

Present in the region of the transition from the pocket 13 to the flux barriers 14 are webs 15 or holders on the side of the recesses 12 facing the air gap 7. In addition to the advantage that these webs 15 or holders counteract possible demagnetization phenomena 22 in the case of a sudden short-circuit of the winding system 4, these webs 15 or holders are also suitable for positioning and fixing the permanent magnets 11.

Since, viewed in the axial direction, the rotor 10 has axially layered metal sheets, it is also conceivable in a further embodiment that webs 15 and holders of this kind are present only on every n th metal sheet or alternately. This embodiment is clearly sufficient for positioning the permanent magnets 11 and, depending on the sudden short-circuit to be expected, is also sufficient with respect to the demagnetization phenomena.

FIG. 5 shows a recess 12 symmetrical to the transverse axis 21, with a plurality of permanent magnets 11 being arranged in the pocket 13. The webs 15 or holding elements face the outer side of the rotor 10 or the air gap 7 of the permanently excited synchronous machine.

The permanent magnet arrangement of a pocket 13 can accordingly have one permanent magnet 11 configured in one piece or have a plurality of permanent magnets 11.

The permanent magnets 11 abut against the longitudinal sides 18, 19 of the pocket 13 in a complementary manner. In other words, a continuous contact, optionally with an adhesive layer provided by metal sheets and permanent magnets 11, is present.

As a rule, the pocket 13 is designed to be slightly larger than the permanent magnet 11 since space for joining and/or tolerances has to be taken into account. This optionally free space is then filled with adhesive or casting compound or, with other types of fixing, such as jamming or caulking, can also just be air.

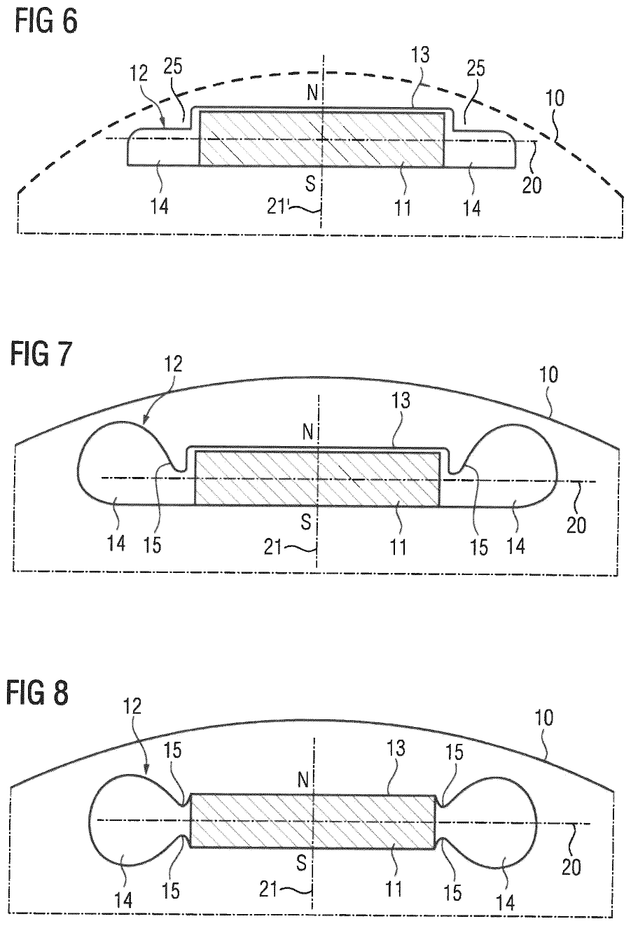

FIG. 6 to FIG. 8 show further embodiments of the holding elements, in particular of the webs 15 and the functional holding webs 25, on a tangential arrangement of a permanent magnet 11 in appropriate recesses 12. Contrary to FIG. 4, in FIG. 6 and FIG. 7 the holding elements and the flux barriers 14 have an axisymmetric construction in respect of the transverse axis 21.

FIG. 8 shows holding elements and flux barriers 14, which have an axisymmetric construction in respect of the transverse axis 21 and longitudinal axis 20.

The poles of the rotor 10, viewed in the circumferential direction, are arranged alternately in respect of their magnetization direction.

FIG. 9 to FIG. 14 show different arrangements of recesses 12 for receiving permanent magnets 11 for designing a pole 23 of the rotor 10. In this case, the air gap densities to be achieved, inter glia, play a role. For reasons of clarity, the holding elements, such as webs 15 or functional holding webs 25, and the flux barriers 14 have been omitted in the case of the recesses 12. However, the embodiments of the flux barriers 14 and of the holding elements from the previous exemplary embodiments can be used arbitrarily.

The quality of the individual permanent magnets 11 per pole 23, as well as the design of the holding elements and the design of the flux barriers 14 can therefore be combined almost arbitrarily. What is crucial is that the holding elements at the side of the recesses 12 facing the external diameter of the rotor 10 are provided in the region between pocket 13 and flux barrier 14 the means for increasing an opposing field stability.

Basically, sheet metal webs 50 are present between the recesses 12 of a pole 23. These sheet metal webs 50 extend between the flux barriers 14 from adjacent recesses 12. These sheet metal webs 50 and their adjacent flux barriers 14 are only schematically represented in the figures for reasons of clarity. This is represented by way of example in the embodiments of FIGS. 3 and 9 to 14. These sheet metal webs 50 have a comparatively narrow configuration and can be magnetically saturated during operation of the electrodynamic machine 1.

The idea underlying the invention may likewise be transferred to permanently excited synchronous machines with external rotors as are used, for example, in directly driven generators of wind power plant.

Rotors 10 of this kind are primarily used in permanently excited synchronous machines, which are operated in the industrial sector. They are provided as drives for pumps, ventilators, compactors, compressors, roller tables, conveying systems, which have a very long continuous operating time. Synchronous machines of this kind can also be used in traction drives, such as mining vehicles, electric busses, trams or trains, in order to guarantee more reliable operation due to an increase in opposing field stability.

1.-7. (canceled)

8. A rotor of a rotatory permanently excited synchronous machine, the rotor comprising:
a magnetically conductive body including substantially axially extending recesses, each of the recesses designed with a pocket;
permanent magnets arranged in the recesses such that the pockets of the recesses receive at least one of the permanent magnets;
flux barriers situated in a longitudinal axis of the recesses at opposed ends of the pockets;
means provided in a region between the pockets and the flux barriers for increasing an opposing field stability at a side of the recesses facing an external diameter of the rotor, said means arranged as holding elements on the ends of the pockets to assist in a positioning and fixing of the permanent magnets in the pockets, said holding elements designed as webs or functional holding webs and having at least one section to form the pockets for receiving the permanent magnets, with the webs or functional holding webs being designed on an air-gap side of the pockets such as to counteract at least in one section an irreversible demagnetization of the permanent magnets in the pockets and to maintain a protective function for the permanent magnets in the event of a fault such as a sudden short-circuit of the permanently excited synchronous machine; and
sheet metal webs arranged between the recesses of a pole of the rotor.

9. The rotor of claim 8, wherein the magnetically conductive body is embodied as an axially layered laminated core.

10. The rotor of claim 8, wherein the recesses are arranged in a V-shape or in a double V-shape or in a U-shape.

11. The rotor of claim 8, wherein the means for increasing an opposing field stability are arranged alternately on the pockets of metal sheets of the rotor in an axial direction of the rotor.

12. The rotor of claim 8, wherein the permanent magnets abut against the air-gap-side longitudinal side in the pockets in a complementary manner.

13. The rotor of claim 8, wherein the flux barriers are arranged at the ends of the pockets, substantially as an extension of the longitudinal axis of the recesses and perpendicular to a magnetization direction of the permanent magnets.

14. The rotor of claim 8, wherein the webs have a radial or quasi radial extension which extends at most up to half of a magnetic thickness of an adjacent one of the permanent magnets in the pockets.

15. The rotor of claim 14, wherein the radial or quasi radial extension is at least 1 mm.

16. The rotor of claim 8, wherein at least one of the permanent magnets is provided per pole and/or recess.

17. A permanently excited synchronous machine, comprising:
a stator; and
a rotor spaced apart from the stator by an air gap, said rotor comprising a magnetically conductive body including substantially axially extending recesses, each of the recesses designed with a pocket, permanent magnets arranged in the recesses such that the pockets of the recesses receive at least one of the permanent magnets, flux barriers situated in a longitudinal axis of the recesses at opposed ends of the pockets, means provided in a region between the pockets and the flux barriers for increasing an opposing field stability at a side of the recesses facing an external diameter of the rotor, said means arranged as holding elements on the ends of the pockets to assist in a positioning, and fixing of the permanent magnets in the pockets, said holding elements designed as webs or functional holding webs and having at least one section to form the pockets for receiving the permanent magnets, with the webs or functional holding webs being designed on an air-gap side of the pockets such as to counteract at least in one section an irreversible demagnetization of the permanent magnets in the pockets and to maintain a protective function for the permanent magnets in the event of a fault such as a sudden short-circuit of the permanently excited synchronous machine, and sheet metal webs arranged between the recesses of a pole of the rotor.

18. The permanently excited synchronous machine of claim 17, wherein the magnetically conductive body of the rotor is embodied as an axially layered laminated core.

19. The permanently excited synchronous machine of claim 17, wherein the recesses are arranged in a V-shape or in a double V-shape or in a U-shape.

20. A conveying system, compressor, compactor or traction drive, comprising a permanently excited synchronous machine as set forth in claim 17.
